(19) United States
(12) Patent Application Publication
(10) Pub. No.: US 2009/0232283 A1
(43) Pub. Date: Sep. 17, 2009

(54) System and Method for Dynamic Adjustment of a Transfer Strategy

(76) Inventors: Lan Zhang, Wayne, PA (US); Harry E. Blanchard, Rumson, NJ (US); Steven H. Lewis, Middletown, NJ (US); Gregory Pulz, Cranbury, NJ (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/048,362

(22) Filed: Mar. 14, 2008

(51) Int. Cl. H04M 1/64

(52) U.S. Cl. 379/80

(57) ABSTRACT

A method for determining a value for a call center, the value relating to an availability of the call center and setting a transfer strategy of an automated interactive voice response system based on the value. In addition, a system having a strategy adjustment module monitoring a call center and determining a value for the call center, the value relating to an availability of the call center and an automated response module setting a transfer strategy to transfer calls to the call center based on the value.

### BACKGROUND INFORMATION

A business may use an automated call center to aid callers in various respects according to the type of business. The automated call center may include an Interactive Voice Response (IVR) system. Callers may be able to solve queries or problems through the IVR system. The callers may also wish to speak to a representative instead of using the IVR system. Initially using the IVR system, the caller may input touchtones, speak commands or be automatically transferred from the IVR system to an appropriate call center representative to resolve their query and/or problem.

In the IVR system, the transfer strategy may be set to “easy to transfer.” In the “easy to transfer” configuration, transfers to representatives may occur whenever the caller requests a representative or if a mistake is made (e.g., automatic transfer). This configuration may produce high levels of caller satisfaction. However, this configuration may also minimize self-service features and also increase a load to a call center which increases call center costs. This configuration may further overwhelm the call center when, for example, the load to the call center is above the call center capacity. The increased waiting time in a queue may result in caller dissatisfaction.

The transfer strategy may also be set to “hard to transfer.” In the “hard to transfer” configuration, transfers to representatives may occur only after several requests are made or only after several re-prompts for mistakes. This configuration may maximize self-service features and reduce a load to a call center. However, this strategy often results frustrates callers, resulting in caller dissatisfaction.

### SUMMARY OF THE INVENTION

A method for determining a value for a call center, the value relating to an availability of the call center and setting a transfer strategy of an automated interactive voice response system based on the value.

In addition, a system having a strategy adjustment module monitoring a call center and determining a value for the call center, the value relating to an availability of the call center and an automated response module setting a transfer strategy to transfer calls to the call center based on the value.

### BRIEF DESCRIPTION OF THE DRAWINGS

FIG. 1 shows a caller system according to an exemplary embodiment of the present invention.

FIG. 2 shows a method for dynamically adjusting a transfer to representatives according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for dynamically adjusting a transfer strategy from an Interactive Voice Response (IVR) system to a representative in a call center. Specifically, the exemplary embodiments of the present invention adapt to caller volume and transfers to representatives depending on a variety of factors such as waiting time for the call center, call centers, or different functional groups of representatives within a call center. The IVR system and the dynamic adjustment will be discussed in more detail below.

Customer satisfaction managers, call center managers, and IVR system designers all often struggle with the transfer strategy to representatives for IVR applications. When using either an “easy to transfer” strategy or a “hard to transfer” strategy, advantages and disadvantages exist where an advantage for an aspect of one is often a disadvantage of the aspect for the other (e.g., load to call centers is increased for the “easy to transfer” strategy while it is decreased for the “hard to transfer” strategy). The exemplary embodiments of the present invention dynamically adjust the transfer strategy so that advantages from both types of strategies may be realized.

It should be noted that the use of two strategies (i.e., “easy to transfer” and “hard to transfer”) is only exemplary. Other transfer strategies may also be a basis for the exemplary embodiments of the present invention so that the advantages of the other transfer strategies may also be realized. For example, an “easiest to transfer” strategy may enable an immediate transfer to a representative when the option is available from an onset of a caller reaching the IVR system. When a queue for the call center is substantially negligible, this strategy may produce the highest level of caller satisfaction. In another example, a “hardest to transfer” strategy may prevent a caller from being transferred to a representative and force the caller to utilize the IVR system to maximize the self-service features. This strategy substantially eliminates the load to the call center. These further examples include respective advantages and disadvantages. The exemplary embodiments of the present invention may also consider these further strategies to include the advantages thereof.

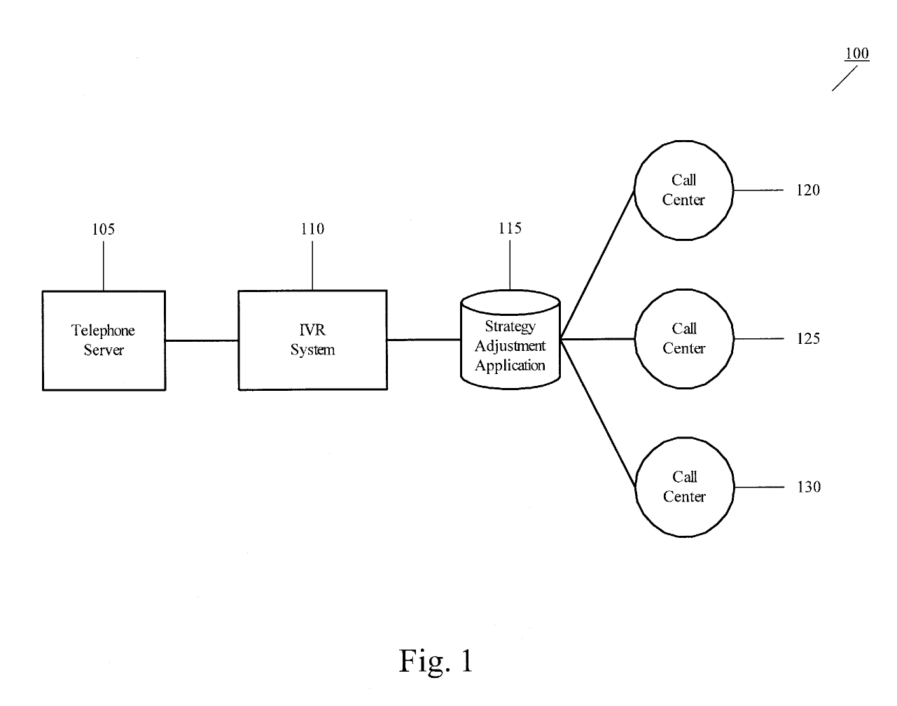

FIG. 1 shows a caller system 100 according to an exemplary embodiment of the present invention. The caller system 100 may represent an exemplary setup for a business in which an incoming call may be handled. Specifically, the caller system 100 handles the call by initially forwarding the call to an IVR system 110. Subsequently, the call may be forwarded to a representative when requested by the caller or when predetermined criteria are met for an automated call forward. The caller system 100 may include a telephone server 105, the IVR system 110, a strategy adjustment application (SAA) 115, and call centers 120-130.

The telephone server 105 may be a gateway for the business utilizing the IVR system 110. The telephone server 105 may also be an intermediary such as a telephone service provider that forwards calls to a destination. Thus, calls made to the telephone server 105 that are destined for the business may be received by the IVR system 110. It should be noted that the use of the telephone server 105 is only exemplary. The caller system 100 may be equipped to directly receive calls. It should also be noted that the use of a single telephone server 105 is only exemplary. The caller system 100 may be connected to a plurality of telephone servers.

The IVR system 110 may include routing, based on software or hardware, that is configured to receive some or all incoming calls that are forwarded from the telephone server 105. The IVR system 100 may be equipped with touchtone and/or automatic speech recognition protocols so that a caller may enter at least one number and/or voice command to activate a particular functionality. For example, the IVR system 100 may begin each call by identifying the caller. The caller may spell out a last name, enter an identification number, etc. The IVR system 100 may also offer a menu in which the caller may select an option. For example, with a computer company, the menu may include a billing/financing option, a technical support option, an order status option, a general help option, etc. The IVR system 110 may also enable the caller to request a representative immediately. However, this option may not be presented or available when predetermined conditions are determined to exist at the time a given call is answered. The predetermined conditions will be described in further detail below.

The call centers 120-130 may be a plurality of divisions in which representatives may assist the caller. The call centers 120-130 may be, for example, a finance department, a technical support department, a general help department, etc. It should be noted that the call centers 120-130 are only exemplary. The call system 100 may include a single call center, more than three call centers, etc.

The strategy adjustment application (“SAA”) 115 may be an application used with the IVR system 110. The SAA 115 may determine the transfer strategy at any given time. Thus, according to the exemplary embodiments of the present invention, the IVR system 110 may refer to the SAA 115 prior to executing a transfer to a representative of a call center. It should be noted that the SAA 115 disposed as a separate component of the call system 100 is only exemplary. The SAA 115 may be, for example, a program of the IVR system 110. The SAA 115, the IVR system 110, a combination thereof, a separate database of the caller system 100, etc. may include a memory storing the predetermined conditions that indicate the transfer strategy to be used when a transfer to a representative is to be executed. The SAA 115 may determine data from each of the call centers 120-130 indicating a status of the respective call center. The SAA 115 may determine this data continuously or at predetermined intervals (e.g., every hour, every half hour, every fifteen minutes, every five minutes, etc.).

According to the exemplary embodiments of the present invention, depending on the appropriate call center for the transfer and the respective status of the call centers, the SAA 115 may determine the transfer strategy to be used for a transfer to a representative of the call center. The use of different transfer strategies according to the status of the call center optimizes call center usage while preventing an overload of the call center. That is, long queue waiting is avoided and caller frustration is minimized.

The SAA 115 may calculate a transfer level value based on the status of the call center as a function of the predetermined criteria. For example, if a percentage of active working representatives is low, the SAA 115 may calculate the value as “1” and set the transfer strategy to “easy to transfer.” Accordingly, if a threshold percentage of the active working representatives is busy, the SAA 115 may calculate the value as “4” and set the transfer strategy to “hard to transfer.” Other examples may include when the SAA 115 calculates the value as “0” and sets the transfer strategy to “easiest to transfer” when no active working representative is occupied with a call; or calculating the value as “5” and setting the transfer strategy to “hardest to transfer” when all active working representatives are occupied with a call; etc.

The SAA 115 may monitor each call center 120-130 and determine a value for the status of the call center. By comparing this value for the status of the call center with the predetermined criterion, the transfer strategy may be determined. The SAA 115 may set the transfer strategy for each call center 120-130 so that when a call arrives at the IVR system 110 and a transfer is requested, the IVR system 110 may first review the transfer strategy set prior to attempting the transfer. For example, when the transfer strategy for the call center 120 is set to “easiest to transfer,” the IVR system 110 may forward the call to the call center 120 to be handled by a representative. In another example, when the transfer strategy for the call center 130 is set to “hard to transfer,” the IVR system 110 may initially prevent the transfer so that the self service functions are continued to be used. When the transfer is prevented, the IVR system 110 may provide further self-service options, provide help prompts, increase the number of re-prompts, etc. In yet another example, when the transfer strategy for the call center 125 is set to “easy to transfer,” the IVR system 110 may include at least one re-prompt prior to forwarding the call as there may be a small queue for the call center 125. As noted above, the transfer strategy settings described herein are exemplary. There may be any number of other transfer strategy settings that may be implemented by the exemplary embodiments. For example, the number of re-prompts on the IVR system 110 may correspond to the calculated value for the call center.

As discussed above, the transfer request to a representative of the call center may be performed directly or indirectly. In a direct transfer request, the caller may indicate to the IVR system 110 that a representative is wanted by pressing at least one touchtone key or speaking a voice command. In an indirect transfer request, the caller may make at least one mistake (e.g., incorrect values inputted for prompts, misinterpreted voice commands are input, etc.) indicating a transfer to a representative is required; or, similarly, the caller may initiate such an indirect transfer request by failing to provide any input in one or more turns.

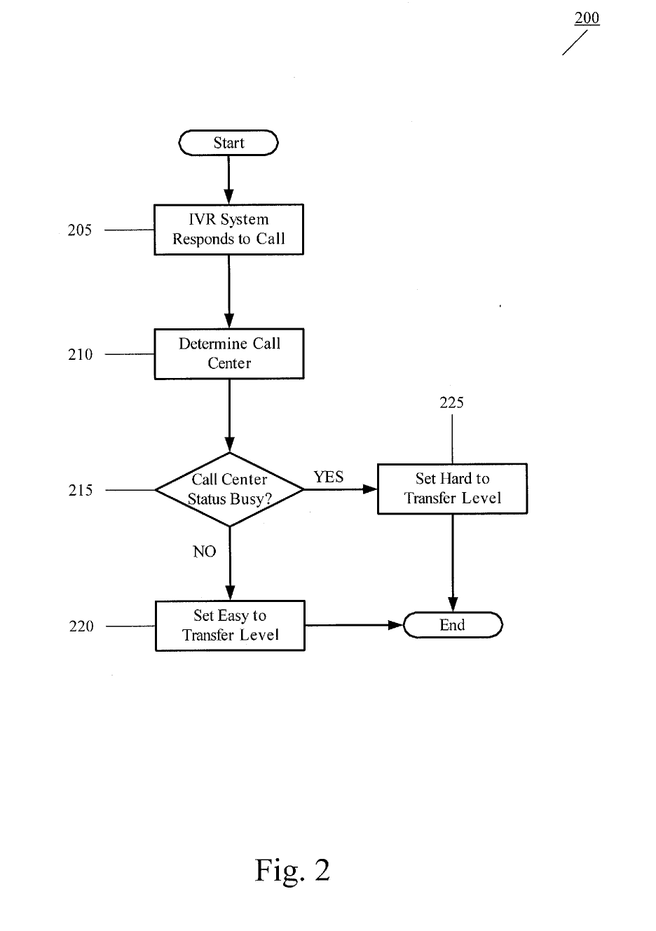

FIG. 2 shows a method 200 for dynamically adjusting a transfer to representatives according to an exemplary embodiment of the present invention. The method 200 may be used to determine a transfer strategy for a call that may be transferred to a representative of a call center. The transfer strategy may be determined as a function of a transfer level value. The method 200 will be described with reference to the call system 100 of FIG. 1.

In step 205, the IVR system 110 responds to a call. As discussed above, the IVR system 110 may be an initial responder to a call being forwarded from the telephone server 105. The IVR system 110 may provide a menu in which the caller may select different options with respect to the problem or query. The use of the menu with a predetermined set of prompts may enable the IVR system 110 to identify the caller, identify the problem or query to be addressed, etc.

In step 210, the appropriate call center is determined. Depending on the selections of the menu, responses to the prompts, etc., a specific call center (e.g., call centers 120-130) may be ascertained to properly address the problem or query. For example, with a problem with billing, a call center that is designated for finances may be appropriate. The IVR system 110 may determine the appropriate call center.

In step 215, the transfer level value is determined. When a call center is particularly busy (e.g., all representatives are occupied with other calls), the transfer level value may be high (e.g., “5”). When a call center is idle (e.g., all representatives are not occupied), the transfer level value may be low (e.g., “0”). The SAA 115 may calculate these values.

When the transfer level is low, the method 200 continues to step 220. In step 220, the SAA 115 sets the transfer strategy to “easy to transfer.” When the transfer level value is high, the method 200 continues to step 225. In step 225, the SAA 115 sets the transfer strategy to “hard to transfer.”

Depending on what transfer strategy is set, the IVR system 110 may handle the call with respective options. For example, when the transfer strategy is “easy to transfer,” the IVR system 110 may offer an option in the menu for a transfer to a representative to the appropriate call center, or the appropriate functional group within a call center. The IVR system 110 may also determine to automatically transfer the call to a representative of the appropriate call center when predetermined criteria are met (e.g., mistakes are made using the IVR system 110, the problem or query to be addressed can only be handled by representatives, etc.). It should be noted that when the transfer level value is low, a potential waiting time to connect to a representative may be short.

When the transfer strategy is “hard to transfer,” the IVR system 110 may suppress an option in the menu for a transfer to a representative until predetermined criteria are satisfied. For example, not until a set number of re-prompts have been presented. Upon receiving replies to each re-prompt, the IVR system 110 may determine that further response to the call may require a representative of an appropriate call center. Thus, the IVR system 110 may forward the call. In another example, the IVR system 110 may continue to be used if the transfer strategy dictates that transfers to representatives of the appropriate call center, or to representatives in specific functional groups within a call center, are not allowed. It should be noted that when the transfer level value is high, the potential waiting time to connect to a representative when the IVR system 110 forward the call to a call center may be long.

It should be noted that the method 200 may include additional steps. For example, after setting the transfer strategy to “hard to transfer,” the transfer level value may again be determined to ascertain if the status of the call center has changed. As discussed above, the SAA 115 may determine the transfer level value of a call center at a variety of times (e.g., continuous, periodic, etc.). An alteration of the transfer level value may not automatically warrant a change in the transfer strategy. For example, if the transfer level value was determined to be “5” in step 220 and the transfer level value was determined to be “4” in step 235, the transfer strategy may remain constant (e.g., “hard to transfer”). The predetermined criteria may dictate when the transfer strategy is to be changed. For example, with the transfer level value being “5” (e.g., “hardest to transfer”), the call may not be transferred during this time. With the transfer level value being “4” (e.g., “hard to transfer”), the call may be transferred upon a set number of re-prompts being performed.

In another example, upon setting the transfer strategy, a determination may be made whether the load value for the appropriate call center has changed. For example, while in the “hard to transfer” transfer strategy, the IVR system 110 may continuously offer menu options (e.g., help choice, re-prompts, etc.). During the course of answering the prompts, the IVR system 110 may determine that another call center may provide assistance to the problem or query. If the call center has changed (e.g., the determined call center does not handle the problem or query), the method 200 may return to step 210 to re-determine the appropriate call center.

Those skilled in the art will understand that the above described exemplary embodiments may be implemented in any number of manners, including, as a separate software module, as a combination of hardware and software, etc. For example, the SAA 115 may be a program of the IVR 110 containing lines of code that, when compiled, may be executed on a processor. Further, a specific call center may be a specific set of representatives within a given call center.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
determining a value for a call center, the value relating to an availability of the call center; and
setting a transfer strategy of an automated interactive, voice response system based on the value.

2. The method of claim 1, further comprising:
receiving, by the automated interactive voice response, a call, the automated interactive voice response providing self-service functions; and
transferring the call to the call center based on the transfer strategy.

3. The method of claim 1, wherein the automated interactive voice response is configured to receive at least one of key commands and voice commands, the key commands and the voice commands relating to options of the automated interactive voice response.

4. The method of claim 1, wherein the value for the call center is determined one of continuously and periodically.

5. The method of claim 1, further comprising:
determining a further value for the further call center; and
setting a further transfer strategy based on the further value.

6. The method of claim 1, wherein the value is based on a number of representatives currently available at the call center.

7. The method of claim 1, wherein the transfer strategy includes enabling a command of the automated interactive voice response to allow a user to select to be transferred to the call center.

8. The method of claim 1, wherein the transfer strategy includes a criteria to be satisfied prior to transferring the call from the automated interactive voice response to the call center.

9. The method of claim 8, wherein the criteria is a predetermined number of re-prompts by the automated interactive voice response.

10. The method of claim 8, wherein the criteria is a detection of an error by a user of the automated interactive voice response.

11. The method of claim 1, wherein the transfer strategy includes enabling a set of help menus in the automated interactive voice response.

12. The method of claim 1, wherein the call center includes a functional group of representatives within a call center.

13. A system, comprising:
a strategy adjustment module monitoring a call center and determining a value for the call center, the value relating to an availability of the call center; and
an automated response module setting a transfer strategy to transfer calls to the call center based on the value.

14. The system of claim 13, wherein the automated response module receives a call, and executes the transfer strategy for the call.

15. The system of claim 13, wherein the automated response module is configured to receive at least one of key commands and voice commands, the key commands and the voice commands relating to options of the automated response module.

16. The system of claim 13, wherein the call center includes a functional group of representatives within a call center.

17. The system of claim 13, wherein the strategy adjustment module monitors a further call center and determines a further value for the further call center, the value relating to an availability of the further call center and the automated response module sets a further transfer strategy to transfer calls to the further call center based on the value.

18. The system of claim 13 wherein the value is based on a number of representatives currently available at the call center.

19. The system of claim 13, wherein the transfer strategy includes one of enabling a command of the automated response module to allow a user to select to be transferred to the call center, enabling a criteria to be satisfied prior to transferring the call from the automated response module to the call center and enabling a set of help menus in the automated response module.

20. The system of claim 19, wherein the criteria is one of a predetermined number of re-prompts by the automated response module and a detection of an error by a user of the automated response module.

21. A computer readable storage medium including a set of instructions executable by a processor, the set of instructions operable to:
determine a value for a call center, the value relating to an availability of the call center; and
set a transfer strategy of an automated interactive voice response based on the value.
